(19) United States
(12) Patent Application Publication
(10) Pub. No.: US 2002/0008719 A1
(43) Pub. Date: Jan. 24, 2002

(54) Internet database

(76) Inventors: Dai Miyawaki, Kawasaki (JP); Yukio Hirayama, Kawasaki (JP); Keisuke Imaizumi, Kawasaki (JP); Takeshi Matsushita, Kawasaki (JP); Miharu Arai, Kawasaki (JP); Yukiyasu Nakagawa, Kawasaki (JP); Hiroshi Ichimura, Nagano (JP); Hidenori Fukushima, Nagano (JP)

Correspondence Address: STAAS & HALSEY LLP, 700 11TH STREET, NW, SUITE 500, WASHINGTON, DC, 20001, US

(21) Appl. No.: 09/892,622

(22) Filed: Jun. 28, 2001

(30) Foreign Application Priority Data
Jun. 28, 2000 (JP) 2000-194565
Jun. 8, 2001 (JP) 2001-173928

(51) Int. Cl. G09G 5/00

(52) U.S. Cl. 345/764

(57) ABSTRACT

When various image data etc. published on a Web are used in an application of a client, a system of inserting all necessary information into the application only in a simple operation such as a dragging-and-dropping operation, etc. is provided. The utilization of the local disk resources of a client can be further improved by referring to target information on a Web. In a client connected to a network such as Internet, etc., the system includes: a unit for inserting image data into the application of the client by dragging and dropping or copying and pasting each type of image data etc. displayed on the Web browser in the client; a unit for obtaining the URL on which the image data are published, and the information about the image data, and managing them as the attribute of the image data.

### BACKGROUND OF THE INVENTION

1. Field of the Invention

The present invention relates to the technology of inserting into an application by an easy operation of a client connected to the network various CAD parts data, image data, etc. provided by a server connected to a network such as Internet, etc. through a Web browser.

2. Description of the Related Art

Recently, the technology of improving the utilization of the local disk resources of a client by selecting, downloading, and using in an application, etc. only the data required by a client 102 from among various data provided by a server 101 connected to a network 103 such as Internet, etc. has been widely used (FIG. 1).

For example, when a user is designing a building using a CAD application in the client 102, it is possible for the user to select only the required data from among various latest CAD parts data, image data, etc. published by a building material manufacturer, etc. on the Web, load the data, and design the building using the downloaded data.

However, it is necessary to perform the designing process after downloading various CAD parts data and image data published on the Web, and the user has to download the data during the designing process, thereby disturbing the efficiency of the process.

On the other hand, there is the technology of generating hyperlinks 205 and 206 on an application 102′ only by dragging and dropping a linked image 203 and a link 204 on a Web browser 201 onto an application 202 of the client 102 using a mouse. For example, if a linked image and a link in Internet Explorer (registered trademark of Microsoft Corp. U.S.A.), which is a Web browser, are dragged and dropped onto Word (registered trademark of Microsoft Corp. U.S.A.), which is an editor application, then a hyperlink can be easily generated in Word (FIG. 2).

However, only a piece of information such as a hyperlink, etc. can be applied to the application of the client. It is actually demanded that various types of information, for example, the name, the model number, etc. of CAD parts can be inserted into the application of the client in one dragging-and-dropping operation.

### SUMMARY OF THE INVENTION

The present invention aims at providing a system capable of inserting all necessary information into the application in a simple operation such as a dragging-and-dropping operation, etc. when various CAD parts data, image data, etc. published on the Web in the application of a client are to be used.

In the conventional system, when various CAD parts data, image data, etc. published on the Web in the application of a client are to be used, target information is downloaded and stored on the local disk of the client, and then the stored data is used. According to the present invention, the utilization of the local disk resources of a client can be further improved by referring to various CAD parts, image data, etc. on the Web without storing target information on the local disk of a client.

To solve the above mentioned problems with the conventional technology, the present invention not only inserts various and image data published on the Web, but also simultaneously inserts the information about the inserted data into the application of the client in a simple operation such as the dragging-and-dropping operation, etc. The inserted CAD parts data and image data are not stored on the local disk of the client, but are referred to on the original Web page.

According to an aspect of the present invention, in a client connected to a network such as Internet, etc., a system includes: a unit for obtaining an operation such as a dragging-and-dropping operation, a copying-and-pasting operation, etc. in the client; and a unit for inserting CAD parts data or the image data into the application of the client by dragging and dropping or copying and pasting each type of CAD parts data and the image data etc. displayed on the Web browser in the client; and a unit for obtaining the CAD parts data and the image data, the URL on which the data are published, and the information about the image data, and managing them as the attribute of the image data; and a unit for referencing the original Web page based on the URL managed as the attribute of the CAD parts data inserted into the CAD application.

With the above mentioned configuration, the work efficiency of the user can be improved much more than the conventional system, and the utilization of the local disk resources of the client can also be improved.

### BRIEF DESCRIPTION OF THE DRAWINGS

FIG. 1 shows the conventional technology (1);

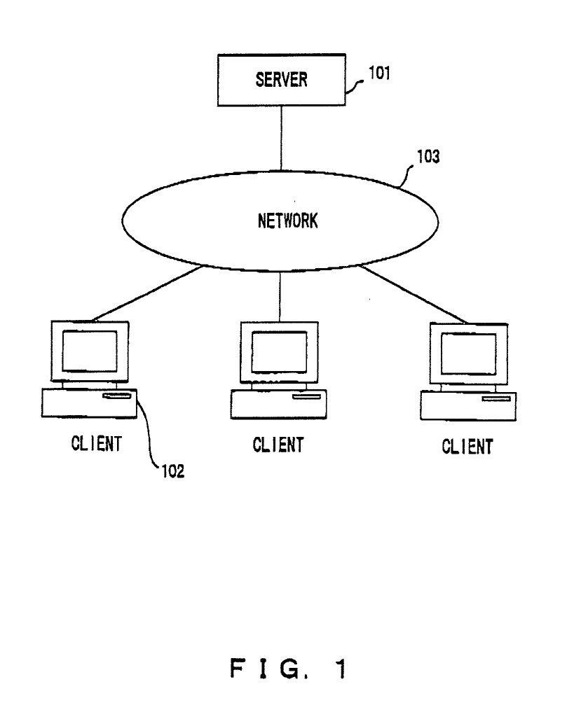

FIG. 2 shows the conventional technology (2);

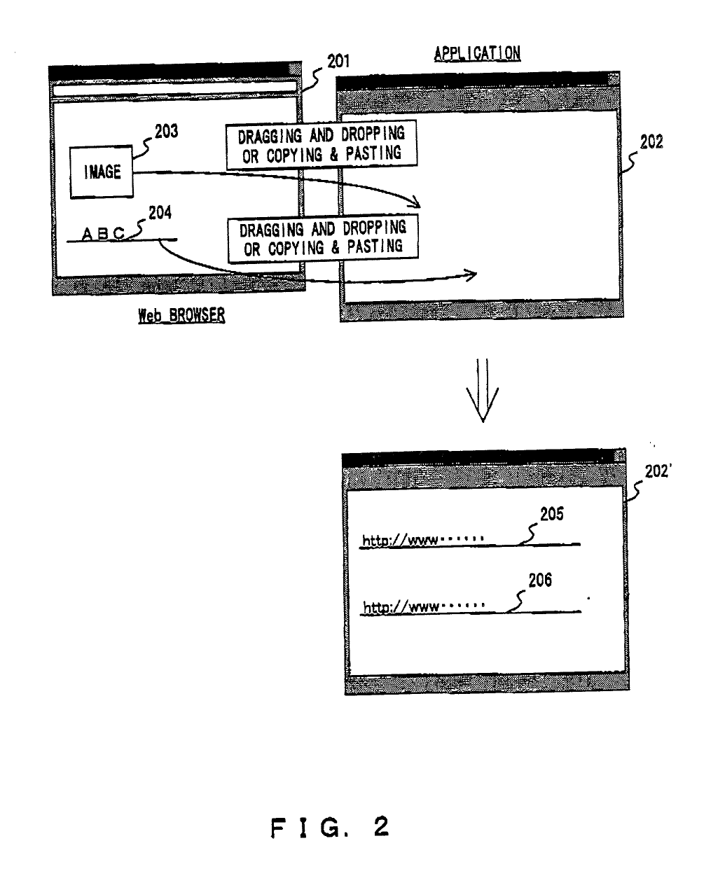

FIG. 3 shows the configuration showing the principle of the present invention;

FIG. 4 shows the process of inserting CAD parts data published on a Web page into the CAD application by a dragging-and-dropping operation or a copying-and-pasting operation;

FIG. 5 is a flowchart of the process performed by the system when the CAD parts data dropped or pasted from a Web page is inserted into a CAD application;

FIG. 6 shows an attribute item of the CAD parts data and the explanation of the data;

FIG. 7 shows a window in which the attribute of the inserted CAD parts data is edited;

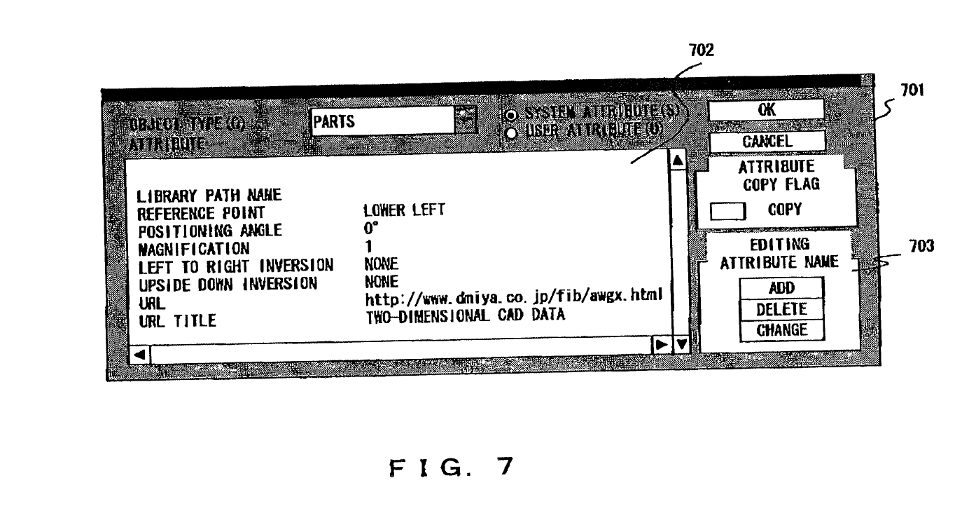

FIG. 8 shows a process of displaying a Web page from the URL managed as an attribute of inserted CAD parts;

FIG. 9 is a flowchart of the process performed by the system when, for example, a Web page is displayed from the URL managed as an attribute of inserted CAD parts;

FIG. 10 shows the process of obtaining updated information about the Web page corresponding to each URL of the URL list, and notifying the user of the information;

FIG. 11 is a flowchart of the process performed by the system when updated information about the Web page corresponding to each URL of the URL list is obtained, and the user is notified of the information;

FIG. 12 shows the process of obtaining the updated information about the CAD parts inserted into the CAD application from the Web page;

FIG. 13 is a flowchart of the process performed by the system when the updated information about the CAD parts inserted from the Web page is obtained and reflected;

FIG. 14 shows an information processing device according to the present invention; and

FIG. 15 shows the method of distributing a software program, etc. according to the present invention.

### DESCRIPTION OF THE PREFERRED EMBODIMENT

The embodiments of the present invention are described below by referring to the attached drawings.

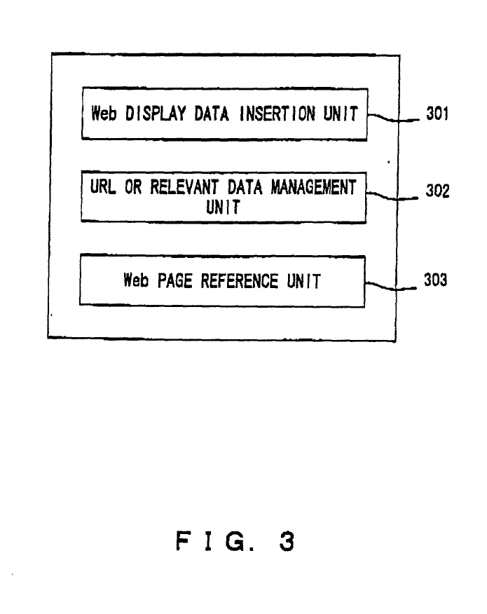

FIG. 3 shows the configuration indicating the principle of the present invention comprising a Web display data insertion unit 301, a URL or relevant data management unit 302, and a Web page reference unit 303. The Web display data insertion unit 301 inserts the CAD parts data and the image data into the application by dragging and dropping or copying and pasting various CAD parts data, image data, etc. displayed on the Web browser. The URL or relevant data management unit 302 obtains together with the CAD parts data and the image data the URL and the information about the image data, and manages them as the attributes of the image data. Furthermore, the Web page reference unit 303 refers to the original Web page based on the URL managed as the attribute of the CAD parts data inserted into the CAD application.

Described below furthermore in detail is the embodiment of the present invention.

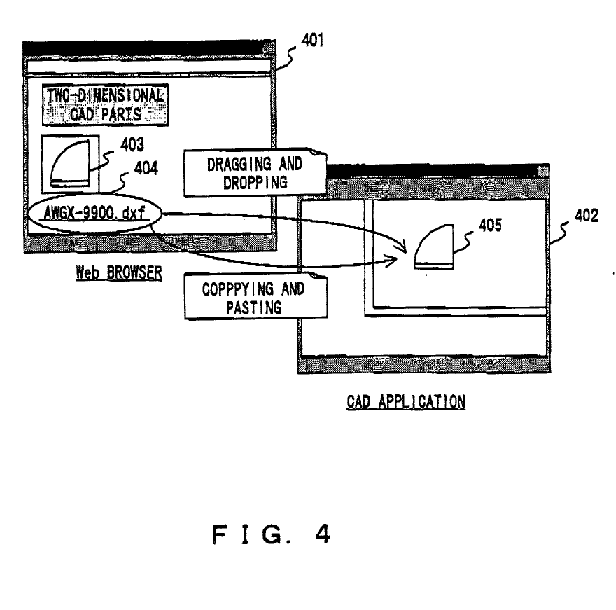

FIG. 4 shows the process of inserting the CAD parts data published on the Web into the CAD application of the client in the dragging-and-dropping or copying-and-pasting operation. CAD parts 405 can also be inserted into a CAD application 402 by dragging and dropping or copying and pasting CAD parts 403 displayed on a Web browser 401 or a link destination 404 of the data file of the CAD parts using a mouse.

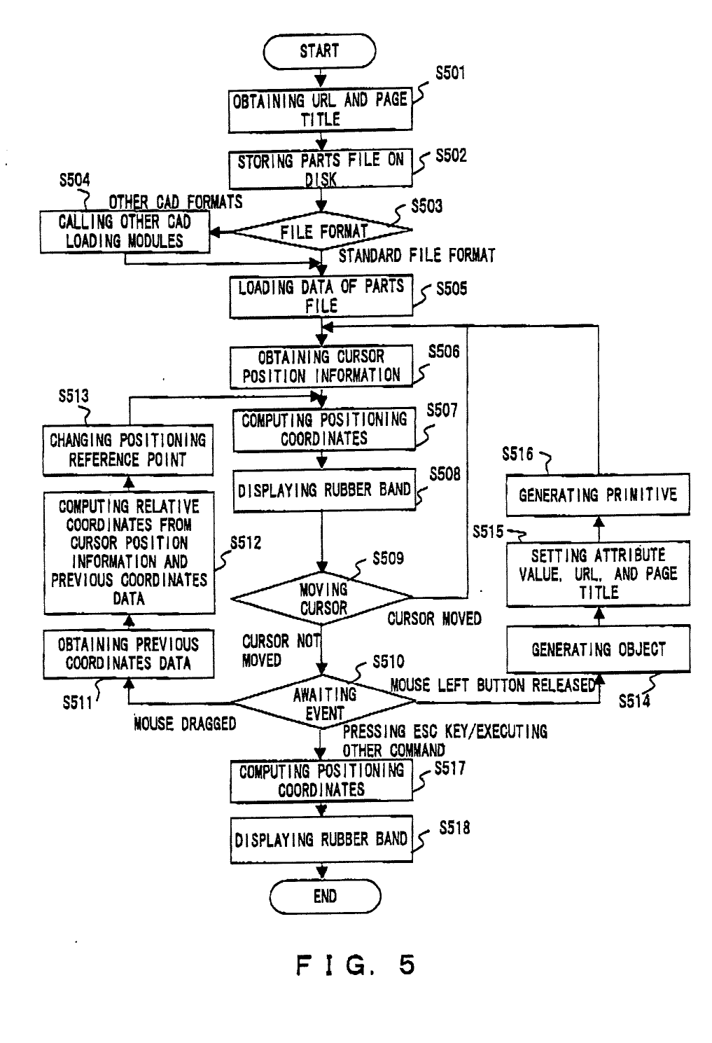

FIG. 5 is a flowchart of the process performed by the system when the CAD parts are inserted into the CAD application by dropping or pasting the CAD parts from the Web as shown in FIG. 4.

First, the URL and the page title displayed on the Web browser are obtained in S501. In S502, the data file of the CAD parts is stored on the local disk. In S503, the type of the format of the stored file is discriminated. If it is a standard file format, control is passed to S505. If it is not a standard file format, then control is passed to S504, and a module is activated to load another CAD application.

In S505, the data file of the CAD parts is loaded. In S506, the position information about the mouse cursor is obtained. In S507, the display position of the CAD parts is computed according to the position information about the mouse cursor obtained in S506. In S508, the CAD parts are displayed in a rubber-banding format based on the computation result obtained in S507.

In S509, it is determined whether or not the mouse cursor has been moved. If yes, then control is returned to S506, and the processes in S506 through S509 are repeated. If not, control is passed to S510, and the system enters an event waiting state.

The previous coordinate data is obtained in S511 when the mouse is dragged in S510. In S512, the relative coordinates are computed from the cursor position information and the previous coordinate data. In S513, the positioning reference point for rubber banding display is changed, and control is returned to S507. Then, the processes in S507 through S510 are repeated.

When the left mouse button is released in S510, control is passed to S514, and the CAD application generates a CAD parts object. In S515, the attribute value of the generated CAD parts, the URL of the Web page, the page title, etc. are set. In S516, the lines, etc. of the CAD parts are drawn in detail (generation of primitive), and the parts are applied onto the CAD application. Then, control is returned to S506, and the processes in S506 through S510 are repeated. Various attribute items such as the object name, the URL, the URL title (Web page title), etc. are set in S515.

When the ESC key is pressed or another command is executed in S510, the parts data obtained from the web page is discarded in S517, and the parts file data stored on the local disk is deleted in S518. Since the parts file data is deleted, the data obtained from the Web page is not left on the local disk.

The process shown in FIG. 5 relates to the process performed by the Web display data insertion unit 301 or the URL or relevant data management unit 302 shown in FIG. 3.

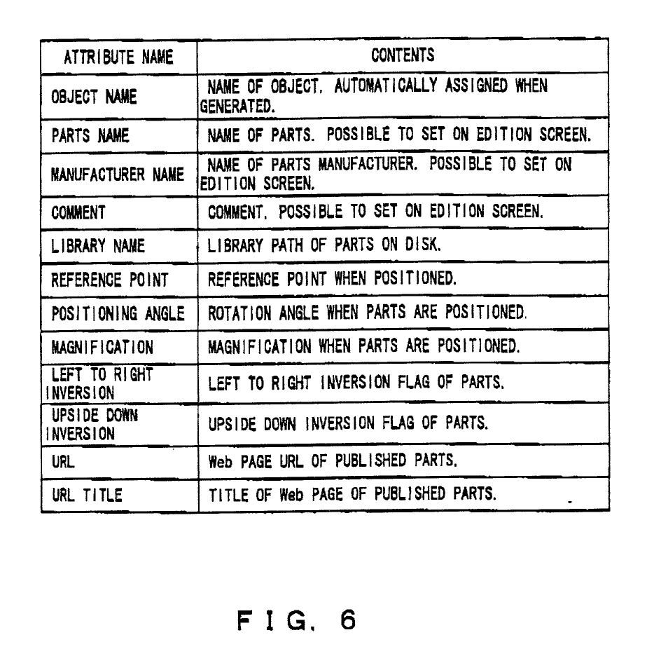

Described above is the flow of the process performed by the system as shown in FIG. 4. In the above mentioned process, after the parts have been inserted into the CAD application, the attribute of the target parts can be edited. When the right button is clicked on the CAD parts object to be processed in the CAD application, then a pop-up menu is displayed. If an attribute edition menu is selected from the displayed pop-up menu, then an attribute edition window 701 is activated. In this attribute edition window 701, an attribute corresponding to each attribute item shown in FIG. 6 is described (702) Attributes to be edited are selected from among the attribute group, and a corresponding editing button 703 is clicked, thus performing an editing process.

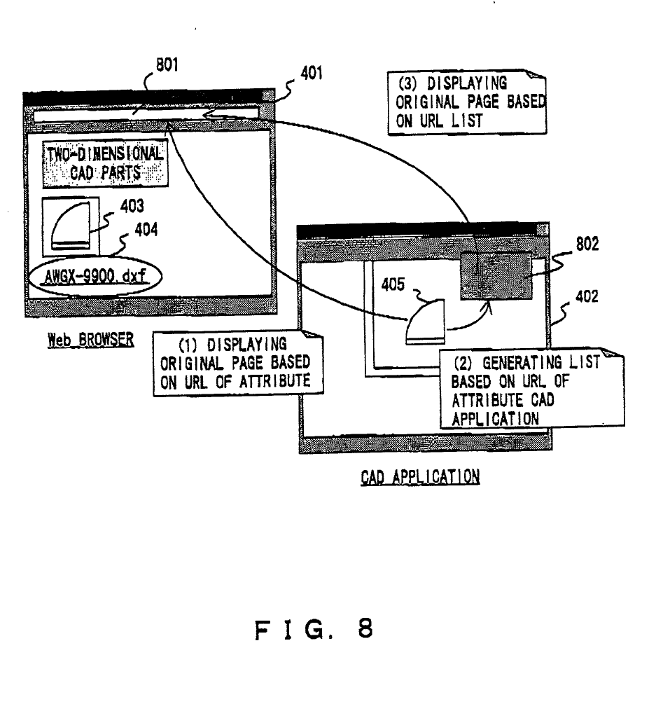

Described next are the processes of displaying a Web page from the URL managed as an attribute of the CAD parts inserted into the application, generating a URL list from the URL corresponding to the plural inserted CAD parts in the CAD application, etc. FIG. 8 shows the processes.

In the process (1) shown in FIG. 8, the pop-up menu is opened by clicking the right button of the mouse on the CAD parts 405 in the CAD application 402. When the ‘open the URL list’ menu is selected from the pop-up menu, the URL managed as an attribute of the CAD parts is pasted on a URL display unit 801 of the Web browser 401, and the corresponding Web page is displayed.

In the process (2) shown in FIG. 8, the pop-up menu is opened by clicking the right button of the mouse on the CAD parts 405 in the CAD application 402. When the ‘add to the URL list’ menu is selected from the pop-up menu, the URL stored as an attribute of the CAD parts 405 is added to a URL list 802. The URL added to the URL list 802 is not deleted although the CAD parts 405 corresponding to the URL have been deleted from the CAD application 402. That is, the URL is constantly stored in the URL list 802 after the CAD application 402 is activated.

In the process (3) shown in FIG. 8, a corresponding Web page is displayed when the user selects a desired URL from the URL list 802 of the CAD application 402.

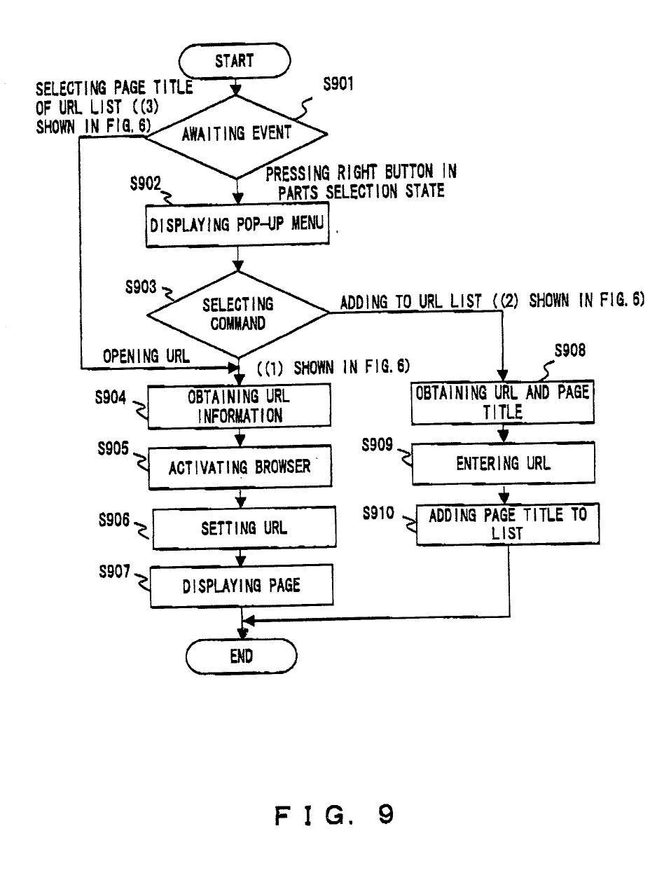

FIG. 9 is a flowchart of the process performed by the system when a Web page is displayed according to the URL managed as an attribute of the CAD parts inserted as shown in FIG. 8.

First, an event is awaited in S901. When an event of selecting a page title of the URL list occurs, control is passed to S904. When an event of pressing the right button of the mouse occurs in the parts selection state in S901, the pop-up menu is displayed in S902. In S903, it is determined which menu has been selected from the pop-up menu. If the ‘open the URL’ menu is selected, then control is passed to S904. If the ‘add to the URL list’ menu is selected, then control is passed to S908.

In S904, the corresponding URL information is obtained, and the Web browser is activated in S905. Then, the URL obtained in S904 is set in the Web browser, and the corresponding Web page is displayed in S907, thereby terminating a series of processes.

In S908, the URL and the page title managed as attributes of the CAD parts are obtained, and the obtained URL is entered in the URL list in S909. In S910, the page title is added to the URL list, thereby terminating a series of processed.

The process shown in FIG. 9 relates to the process performed by the URL or relevant data management unit 302 shown in FIG. 3, The URL or relevant data management unit 302 has the function of managing the URL, the relevant data, etc. FIG. 9 actually shows how the information managed by the URL or relevant data management unit 302 is used.

Described below is the process of obtaining updated information about the Web page corresponding to each URL in the CAD application, and notifying the user of the information.

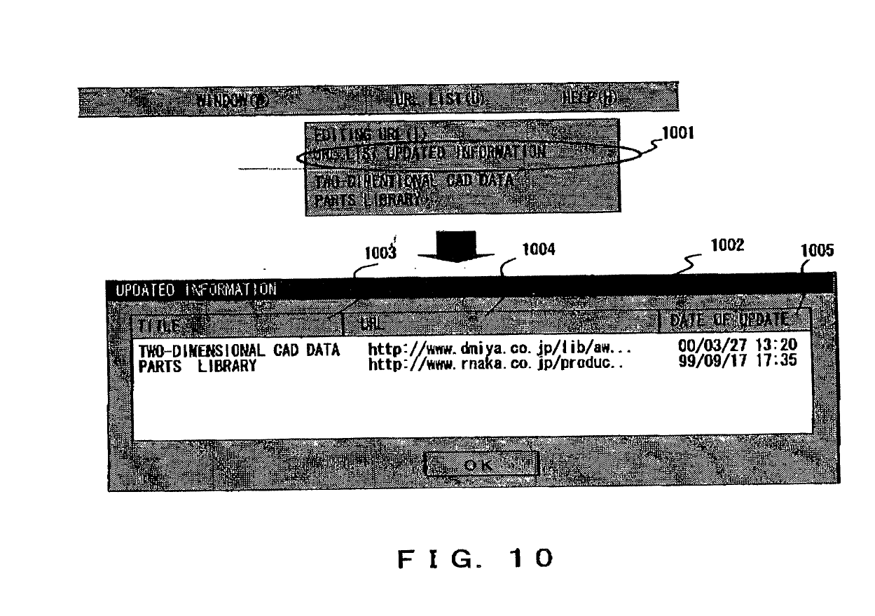

In FIG. 10, if a menu 1001 ‘URL list updated information’ is selected from the menu of the CAD application, the updated information about the Web page corresponding to each URL stored in the URL list is obtained, and a window 1002 displaying the updated information is activated. A Web page title 1003, a URL 1004, and a date of update 1005 are displayed in the window 1002.

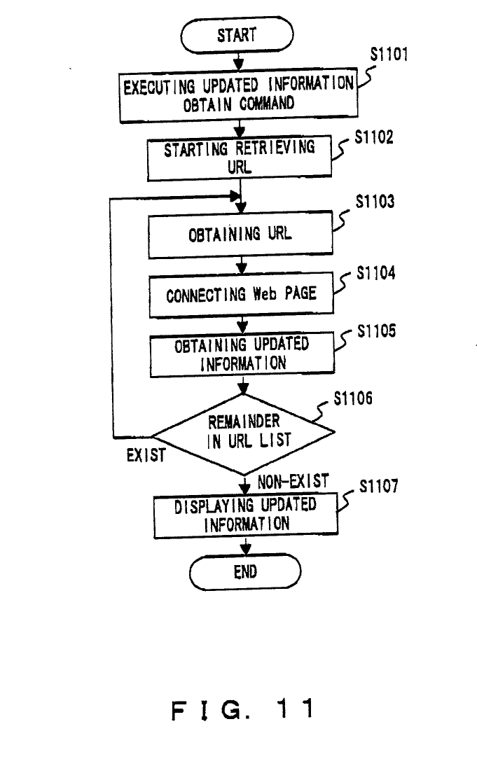

FIG. 11 is a flowchart of the process performed by the system when the updated information about the Web page corresponding to each URL in the URL list shown in FIG. 10 is obtained, and the user is notified of the information.

First, in S1101, the ‘URL list updated information’ menu is selected from the CAD application, and the updated information obtain command is executed. In S1102, the process of retrieving the URL in the URL list is started. In S1103, the URL is obtained. In S1104, the Web page corresponding to the obtained URL is connected. In S1105, the updated information about the Web page is obtained. In S1106, it is determined whether or not there is an unconnected Web page remaining in the URL list. If yes, control is returned to S1103, and the processes in S1103 through S1106 are repeated. If not, then control is passed to S1107, and the window 1002 which is a list of updated information is displayed, thereby terminating the process.

The process in FIG. 11 corresponds to the process relating to the information managed by the URL or relevant data management unit 302 shown in FIG. 3.

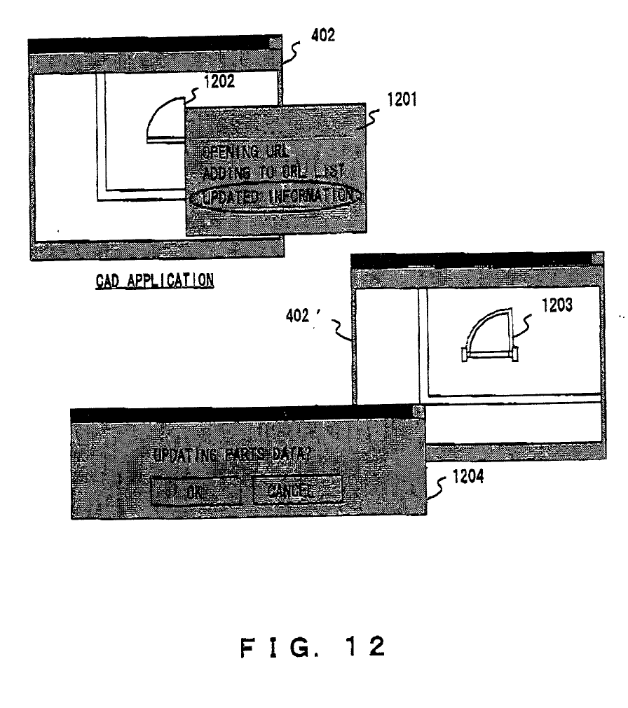

Described below is the process of obtaining the latest information about the parts arranged in the CAD application, and notifying the user of the information as the updated information. FIG. 12 shows the process.

In FIG. 12, a pop-up menu 1201 is displayed by clicking the right button of the mouse on CAD parts 1202 inserted from the Web page in the CAD application 402. If the ‘updated information’ menu is selected from the displayed pop-up menu 1201, then the Web page is referred to based on the URL managed as an attribute of the CAD parts 1202. If the CAD parts 1202 have been updated, then the latest data file of the CAD parts is loaded from the Web page, and a rubber band 1203 is displayed on the CAD parts 1202. Then, a message window 1204 is displayed, and the user is inquired whether or not the CAD parts are to be updated.

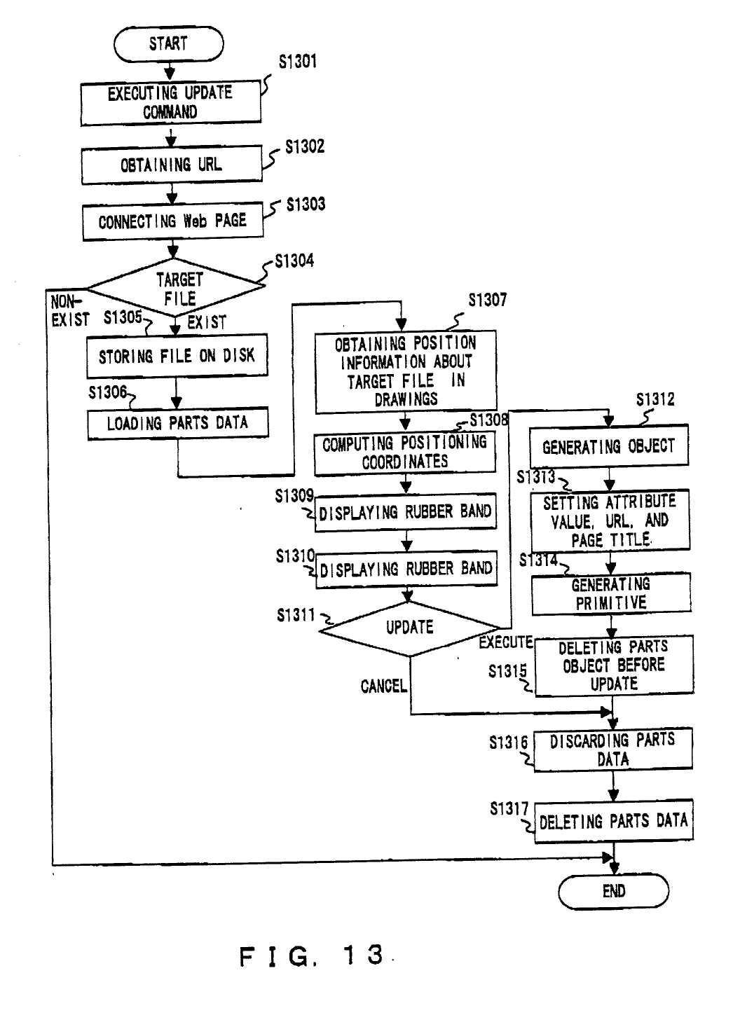

FIG. 13 is a flowchart of the process performed by the system when the updated information about the CAD parts inserted from the Web page as shown in FIG. 12 is obtained and reflected.

First, in S1301, the right button of the mouse is clicked on the CAD parts, the ‘updated information’ menu is selected from the displayed pop-up menu, and a request to obtain the updated information about the target CAD parts is issued. Then, a corresponding URL is obtained in S1302, and a Web page is connected based on the obtained URL in S1303.

In S1304, it is determined whether or not there is an updated data file of the target CAD parts. If not, the process terminates. If yes, control is passed to S1305, and the data file is stored on the disk. In S1306, the parts data is loaded from the stored data file. In S1307, the position information for display of the loaded parts data is obtained. In S1308, the positioning coordinates are computed from the obtained position information, and the rubber band of the new CAD parts is displayed in S1309, In S1310, an update message window for inquiry as to whether or not the user requests to update the target CAD parts is displayed. If the user selects the update, then control is passed to S1312. If the user issues an instruction to cancel the update, then control is passed to S1316.

In S1312, a CAD parts object is generated in the CAD application. In S1313, the attribute value of the generated CAD parts, the URL of the Web page, the page title, etc. are set. In S1314, the lines, etc. of the CAD parts are drawn in detail (generation of primitive), and are pasted onto the CAD application. In S1315, the parts object before the update is deleted, and control is passed to S1316.

In S1316, the parts data obtained from the Web page are discarded. In S1317, the data file of the parts stored on the disk is deleted, thereby terminating the process.

The process shown in FIG. 13 relates to the process performed by the Web page reference unit 303 shown in FIG. 3.

Described above in detail are the embodiments of the present invention. However, the present invention is not limited to the above mentioned embodiments. For example, in the above mentioned embodiments, the CAD parts are inserted from the Web page into the CAD application, but the data published on the Web page can be any type of data file such as images, animation, voice, set files, etc. Furthermore, an application for inserting the data from the Web page can be any type of application such as an editor, a drawing tool, etc. The feature of the present invention resides in that data displayed on a Web page can be inserted into a target application in a simple operation such as a dragging-and-dropping operation, and that the URL, the page title of a Web page, and information relating to the data displayed on the Web page as well as the data displayed on the Web page can be inserted into a target application in one operation.

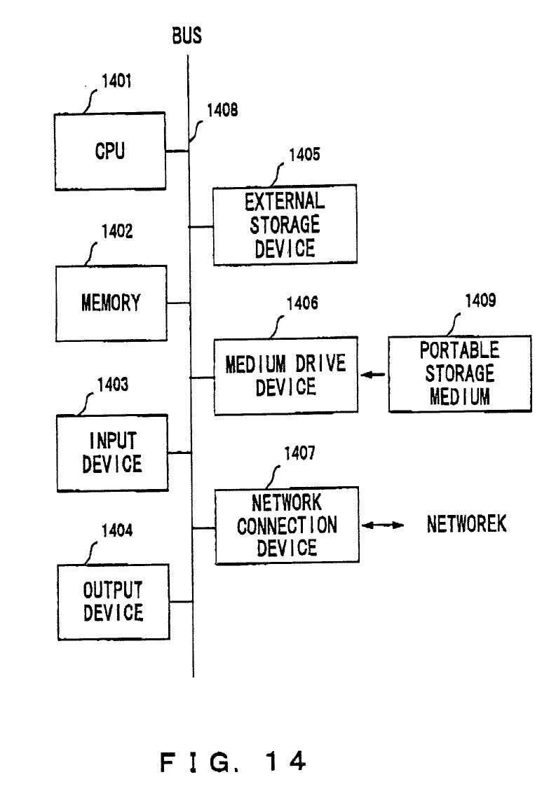

The present invention is realized by the information processing device (computer) as shown in FIG. 14. The information processing device shown in FIG. 14 comprises a CPU (central processing unit) 1401, memory 1402, an input device 1403, an output device 1404, an external storage device 1405, a medium drive device 1406, and a network connection device 1407. These units are interconnected through a bus 1408.

The memory 1402 includes, for example, ROM (Read Only Memory), RAM (Random Access Memory), etc., and stores a program and data used in a process. The CPU 1401 performs a necessary process by executing the program using the memory 1402. That is, the Web display data insertion unit 301, the URL or relevant data management unit 302, and the Web page reference unit 303 according to the present invention are operated by the program stored in the memory 1402.

The user performs an editing operation, etc. using the input device 1403 such as a mouse, a keyboard, etc. of the information processing device while watching the application displayed on the output device 1404 such as the display, etc. of the information processing device.

The external storage device 1405 can be, for example, a magnetic disk device, an optical disk device, a magneto-optical disk device, etc. The information processing device stores the above mentioned program, data, etc. in the external storage device 1405 for use later as necessary by loading them into the memory 1402.

The medium drive device 1406 drives a portable storage medium 1409 to access the stored contents. The portable storage medium 1409 can be any computer-readable storage medium such as a memory card, a floppy disk, CD-ROM (Compact Disk Read Only Memory), an optical disk, a magneto-optical disk, etc. The portable storage medium 1409 stores the above mentioned program and data for use later as necessary by loading them into the memory 1402.

The network connection device 1407 communicates with an external device through an arbitrary network (line) such as a LAN (Local Area Network), etc., and exchange data for communications. The information processing device receives the above mentioned data from an external device through the network connection device 1407 as necessary, and load the data into the memory 1402 for use.

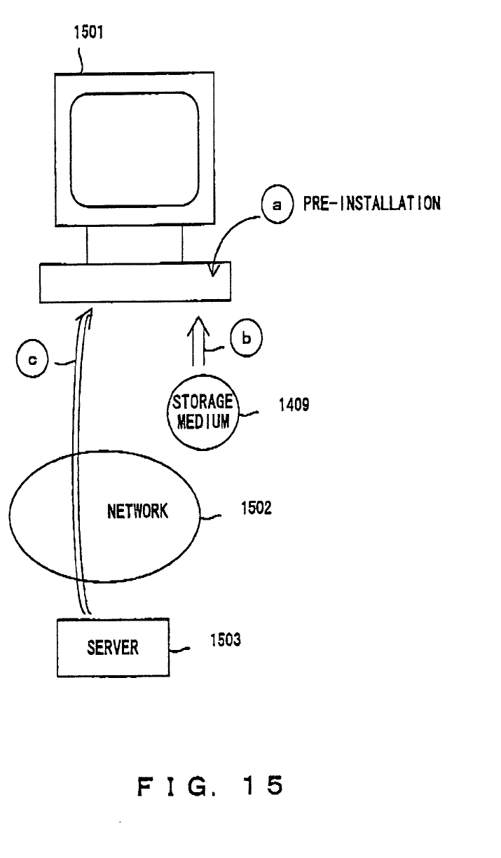

FIG. 15 shows the method of providing a software program, etc. executed by the information processing device according to the present invention. The program, etc. can be provided in any of the three methods (a) through (c) described below.

(a) Provided after being installed in an information processing device 1501 such as a program, etc. In this case, the program, etc. is installed in advance before delivery.

(b) Provided after being stored in the portable storage medium 1409. In this case, a program, etc. stored in the portable storage medium 1409 is installed in the external storage device 1405 of the information processing device 1501 such as a computer, etc.

(c) Provided by a server 1503 of a network 1502. Basically, in this case, the information processing device 1501 such as a computer, etc. obtains a program, etc. by downloading the program, etc. stored in the server 1503.

As described above in detail, according to the present invention, various CAD parts and image data published on a Web, and the information relating to the data published on the Web can be simultaneously inserted into the application of the client in a simple operation such as a dragging-and-dropping operation, etc. Furthermore, the inserted CAD parts data and image data are not stored on the local disk of the client, but can be obtained by referring to the original Web page. Thus, the present invention can realize a higher work efficiency than the conventional technology, and further improves the utilization of the local disk resources of the client.

What is claimed is:

1. A system of obtaining various image data provided by a server connected to a network such as Internet, etc. using a Web browser in a client, and utilizing the data in an application of the client, comprising:
a unit obtaining an operation such as a dragging-and-dropping operation, a copying-and-pasting operation, etc. in the client; and
a unit inserting the image data into the application of the client by dragging and dropping or copying and pasting the image data displayed on the Web browser in the client.

2. The system according to claim 1, further comprising
a unit obtaining, together with the image data, a URL in which the image data is published and information relating to the image data, and managing the URL and information as attributes of the image data.

3. A CAD system of obtaining various CAD parts data provided by a server connected to a network such as Internet, etc. using a Web browser in a client, and utilizing the data in a CAD application of the client, comprising:
a unit obtaining an operation such as a dragging-and-dropping operation, a copying-and-pasting operation, etc. in the client; and
a unit inserting the CAD parts data into the CAD application of the client by dragging and dropping or copying and pasting the CAD parts data displayed on the Web browser in the client.

4. The CAD system according to claim 3, further comprising
a unit obtaining, together with the CAD parts data, a URL in which the CAD parts data is published and information relating to the CAD parts data, and managing the URL and information as attributes of the CAD parts data.

5. The CAD system according to claim 3, wherein
when the CAD parts data is dropped or pasted from the Web browser, the data is automatically converted into a CAD application format of the client and then inserted.

6. The CAD system according to claim 4, further comprising
a unit referring to an original Web page based on a URL managed as an attribute of the CAD parts data inserted into the CAD application.

7. The CAD system according to claim 4, further comprising
a unit generating a URL list from a URL managed as an attribute of plural pieces of CAD parts data inserted into the CAD application.

8. The CAD system according to claim 7, further comprising
a unit obtaining updated information about a Web page corresponding to each URL of the URL list, and notifying a user of the information.

9. The CAD system according to claim 4, further comprising
a unit obtaining updated information on a Web page corresponding to the inserted CAD parts data using a URL managed as an attribute of the inserted CAD parts data, and reflecting a change of information about the inserted CAD parts data.

10. A method of obtaining various image data provided by a server connected to a network such as Internet, etc. using a Web browser in a client, and utilizing the data in an application of the client, comprising:
obtaining an operation such as a dragging-and-dropping operation, a copying-and-pasting operation, etc. in the client; and
inserting the image data into the application of the client by dragging and dropping or copying and pasting the image data displayed on the Web browser in the client.

11. The method according to claim 10, further comprising
obtaining, together with the image data, a URL in which the image data is published and information relating to the image data, and managing the URL and information as attributes of the image data.

12. A method of obtaining various CAD parts data provided by a server connected to a network such as Internet, etc. using a Web browser in a client, and utilizing the data in a CAD application of the client, comprising:
obtaining an operation such as a dragging-and-dropping operation, a copying-and-pasting operation, etc. in the client; and
inserting the CAD parts data into the CAD application of the client by dragging and dropping or copying and pasting the CAD parts data displayed on the Web browser in the client.

13. The method according to claim 12, further comprising
obtaining, together with the CAD parts data, a URL in which the CAD parts data is published and information relating to the CAD parts data, and managing the URL and information as attributes of the CAD parts data.

14. The method according to claim 12, wherein
when the CAD parts data is dropped or pasted from the Web browser, the data is automatically converted into a CAD application format of the client and then inserted.

15. The method according to claim 12, further comprising
referring to an original Web page based on a URL managed as an attribute of the parts data inserted into the CAD application.

16. A computer-readable storage medium storing a program used to direct a computer to perform the steps of obtaining various image data provided by a server connected to a network such as Internet, etc. using a Web browser in a client, and utilizing the data in an application of the client, comprising:
obtaining an operation such as a dragging-and-dropping operation, a copying-and-pasting operation, etc. in the client, and
inserting the image data into the application of the client by dragging and dropping or copying and pasting the image data displayed on the Web browser in the client.

17. The medium according to claim 16, further comprising
obtaining, together with the image data, a URL in which the image data is published and information relating to the image data, and managing the URL and information as attributes of the image data.

18. A computer-readable storage medium storing a program used. to direct a computer to perform the steps of obtaining various CAD parts data provided by a server connected to a network such as Internet, etc. using a Web browser in a client, and utilizing the data in a CAD application of the client, comprising:
obtaining an operation such as a dragging-and-dropping operation, a copying-and-pasting operation, etc. in the client; and
inserting the CAD parts data into the CAD application of the client by dragging and dropping or copying and pasting the CAD parts data displayed on the Web browser in the client.

19. The medium according to claim 18, further comprising
obtaining, together with the CAD parts data, a URL in which the CAD parts data is published and information relating to the CAD parts data, and managing the URL and information as attributes of the CAD parts data.

20. The medium according to claim 18, wherein
when the CAD parts data is dropped or pasted from the Web browser, the data is automatically converted into a CAD application format of the client and then inserted.

21. The medium according to claim 18, further comprising
referring to an original Web page based on a URL managed as an attribute of the parts data inserted into the CAD application.

22. A program used to direct a computer to perform the steps of obtaining various image data provided by a server connected to a network such as Internet, etc. using a Web browser in a client, and utilizing the data in an application of the client, comprising:
obtaining an operation such as a dragging-and-dropping operation, a copying-and-pasting operation, etc. in the client; and
inserting the image data into the application of the client by dragging and dropping or copying and pasting the image data displayed on the Web browser in the client.

23. The program according to claim 22, further comprising
obtaining, together with the image data, a URL in which the image data is published and information relating to the image data, and managing the URL and information as attributes of the image data.

24. A program used to direct a computer to perform the steps of obtaining various CAD parts data provided by a server connected to a network such as Internet, etc. using a Web browser in a client, and utilizing the data in a CAD application of the client, comprising:
obtaining an operation such as a dragging-and-dropping operation, a copying-and-pasting operation, etc. in the client; and
inserting the CAD parts data into the CAD application of the client by dragging and dropping or copying and pasting the CAD parts data displayed on the Web browser in the client.

25. The program according to claim 24, further comprising
obtaining, together with the CAD parts data, a URL in which the CAD parts data is published and information relating to the CAD parts data, and managing the URL and information as attributes of the CAD parts data.

26. The program according to claim 24, wherein
when the CAD parts data is dropped or pasted from the Web browser, the data is automatically converted into a CAD application format of the client and then inserted.

27. The program according to claim 24, further comprising
referring to an original Web page based on a URL managed as an attribute of the parts data inserted into the CAD application.

28. A system of obtaining various image data provided by a server connected to a network such as Internet, etc. using a Web browser in a client, and utilizing the data in an application of the client, comprising:
means for obtaining an operation such as a dragging-and-dropping operation, a copying-and-pasting operation, etc. in the client; and
means for inserting the image data into the application of the client by dragging and dropping or copying and pasting the image data displayed on the Web browser in the client.
